(19) United States
(12) Patent Application Publication
(10) Pub. No.: US 2026/0340771 A1
(43) Pub. Date: Oct. 29, 2026

(54) METHOD PERFORMED BY AN IMAGE SIGNAL PROCESSOR

(71) Applicant: Arm Limited, Cambridge (GB)

(72) Inventors: Ignazio INDOVINA, Manchester (GB); Maxim NOVIKOV, Sale (GB)

(73) Assignee: Arm Limited, Cambridge (GB)

(21) Appl. No.: 19/652,321

(22) Filed: Apr. 20, 2026

(30) Foreign Application Priority Data
Apr. 25, 2025 (GB) 2506225.8

(51) Int. Cl. G06T 5/20; G06T 3/4015; G06T 5/60; G06T 5/70; G06T 5/73

(52) U.S. Cl. CPC G06T 5/20; G06T 3/4015; G06T 5/60; G06T 5/70; G06T 5/73

(57) ABSTRACT

A method performed by an information processing apparatus is described. The method comprises: obtaining input data, parameterising a kernel that corresponds to a number of applications of a predetermined filter by a continuous variable associated with the number of applications of the predetermined filter, determining a derivative of the kernel applied to the input data with respect to the continuous variable, and outputting the derivative. An information processing apparatus configured to perform the method above is also described.

### CROSS-REFERENCE TO RELATED APPLICATION

This application claims the benefit under 35 U.S.C. § 119(a) and 37 CFR § 1.55 to United Kingdom patent application no. 2506225.8, filed on Apr. 25, 2025, the entire content of which is incorporated herein by reference.

### TECHNICAL FIELD

The present invention relates to methods performed by an image signal processor, an image signal processor, and a non-transitory computer-readable storage medium. The disclosure has particular, but not exclusive, relevance to image processing for computer vision.

### BACKGROUND

Image signal processors (ISPs) are used to process image data to change characteristics of the data. For example, an ISP may reduce noise, correct pixel defects, and/or apply tone mapping. Processed image data from an image signal processor may be used for computer vision purposes. For example, an image could be taken of a street with road signs, vehicles, pedestrians, streetlights and other objects. The image data could be processed by an image signal processor and then sent to a neural network (NN). The NN could then use the processed image data to identify people or objects present in the original image.

In order to improve performance, it is desirable for an ISP to produce output image data that is suitable for use by a NN later in the image processing chain. Use of an ISP in this way may require tuning of the ISP. Conventional approaches may tune the ISP manually for any given task or application. This may produce great-looking images but can be time consuming. Additionally, it is not clear whether ‘good-looking’ images from a human perspective are optimal for computer vision applications. It would be beneficial to tune parameters of an ISP at the same time as training of a neural network e.g. for performing object recognition processes.

### SUMMARY

According to a first aspect of the present invention, there is provided a method performed by an information processing apparatus, the method comprising: obtaining input data; parameterising a kernel that corresponds to a number of applications of a predetermined filter by a continuous variable associated with the number of applications of the predetermined filter; determining a derivative of the kernel applied to the input data with respect to the continuous variable; and outputting the derivative. The kernel may comprise a plurality of coefficients.

The method may further comprise: receiving a rate of change of loss with respect to the coefficient of the kernel from a neural network. The method may multiply the received rate of change of loss by the derivative to determine a rate of change of the loss with respect to the continuous variable. In some implementations, the method may determine a derivative of each coefficient of the kernel applied to the input data with respect to the continuous variable. In such implementations, the method may multiply a received rate of change of loss for each coefficient in the kernel by a respective derivative for that coefficient to determine the rate of change of the loss with respect to the continuous variable. The method may further adjust a number of applications of the predetermined filter based on the determined rate of change of loss with respect to the continuous variable.

The method may yet further comprise using the derivative to obtain a chosen number of applications of the predetermined filter that causes a loss function to meet an exit criteria. The method may store the chosen number of applications.

Adjusting the number of applications of the predetermined filter may comprise: using the rate of change of loss with respect to the continuous variable with a gradient descent algorithm to determine the value of the chosen number of applications. The method may further comprise mapping the value of the chosen number of applications of the predetermined filter to determine an integer chosen number of applications of the predetermined filter. The gradient descent algorithm may be a gradient descent algorithm such as stochastic gradient descent or the ADAM algorithm.

The input data may comprise pixel values. Applying the predetermined filter to the input data may comprise determining a weighted sum of adjacent pixel values of the input data. Applying the predetermined filter to the input data may further comprise bit shifting the summed input data.

The kernel may comprise a plurality of coefficients. The method may further comprise modelling the plurality of coefficients of the kernel as a Gaussian distribution. Parameters of the Gaussian distribution may be determined by the number of applications of the predetermined filter. Determining a derivative of the kernel with respect to the continuous variable may comprise analytically calculating a derivative of the Gaussian distribution with respect to the continuous variable. The derivative of the Gaussian distribution with respect to the number of applications of the predetermined filter may be normalised with respect to a reference value.

In some implementations, the method may further comprise: determining a first kernel, wherein the first kernel corresponds to applying the predetermined filter to the input data a first number of times. The method may comprise determining a second kernel, wherein the second kernel corresponds to applying the predetermined filter to the input data a second number of times. The method may interpolate between entries in the first kernel and entries in the second kernel to obtain a rate of change of the kernel with respect to the continuous variable. Interpolating between the first kernel and the second kernel may comprise linearly interpolating between entries in the first kernel and corresponding entries in the second kernel. Interpolating between the first kernel and the second kernel may comprise non-linearly interpolating between entries in the first kernel and corresponding entries in the second kernel.

The input data may comprise data from an image. The loss function may be calculated by comparing a predicted characteristic of the image to labelled input data in a training set. The loss function may be calculated in a further step using regularisation techniques to reduce the risk of overfitting. The number of applications of the predetermined filter may be stored as a continuous variable. The kernel may be symmetric. The predetermined filter may correspond to a two-dimensional equivalent of a one-dimensional filter (1, 2, 1).

The predetermined filter may be a filter for controlling at least one of image sharpness, image blurring, a demosaicing parameter, a denoising parameter, and a white balance parameter. The outputted derivative may be used to adjust the number of times that the filter is applied for us in at least one of computer vision, image recognition, and object identification. The image signal processor may be usable for object identification in a self-driving vehicle. The derivative may be suitable for use with a PyTorch framework. The derivative may be suitable for use with a TensorFlow framework.

The method may further comprise, in an inference phase, deploying the integer chosen number of times to apply the predetermined filter to an image signal processor. The image signal processor may apply the predetermined filter the integer chosen number of times to second input data that is input during the inference phase to generate processed second input data. The method may further comprise the image signal processor sending the processed second input data to a neural network for inference.

According to a second aspect of the present invention, there may be provided an information processing apparatus. The information processing apparatus may comprise: a storage; and a processor configured to perform the method of the first aspect. The storage of the information processing apparatus may be configured to store one or more settings associated with the information processing apparatus. The information processing apparatus of the second aspect may be configured to store the integer chosen number of times to apply the predetermined filter in memory circuitry. The information processing apparatus of the second aspect may, in some implementations, be further configured to apply the predetermined filter the chosen integer number of times to input data to generate processed input data.

In some implementations, the information processing apparatus may be an image signal processor.

According to a third aspect of the present invention, there may be provided a method performed by a system comprising an image signal processor. The method may comprise: receiving, from an information processing apparatus that performs the method of the first aspect, the integer chosen number of times to apply the predetermined filter; and applying the predetermined filter the integer chosen number of times to second input data that is input during the inference phase to generate processed second input data. The method of the third aspect may further comprise sending, by the image signal processor, the processed second input data to the neural network processor. In some embodiments, the method of the third aspect may further comprise: receiving, by the neural network processor, the processed second input data; and performing inference on the processed second input data using a neural network.

According to a fourth aspect of the present embodiment, there may be provided a system, the system comprising an image signal processor and a neural network processor, wherein the image signal processor is configured to: receive, from an information processing apparatus that performs the method of the first aspect, the integer chosen number of times to apply the predetermined filter; and apply the predetermined filter the integer chosen number of times to second input data that is input during the inference phase to generate processed second input data. The image signal processor may be further configured to send the processed second input data to the neural network processor. In some embodiments, the neural network processor may be further configured to: receive the processed second input data from the image signal processor and perform inference on the processed second input data using a neural network.

According to a fifth aspect of the present invention, there may be provided a non-transitory computer-readable storage medium comprising instructions that, when executed by an image signal processor, cause the image signal processor to perform the method of the first aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows an overview of the hardware that may be present within an information processing apparatus;

FIG. 2 is a schematic diagram showing a system for tuning parameters for an image signal processor and for training a neural network;

FIG. 3 is a schematic diagram showing a system for performing inference using the image signal processor and the trained neural network;

FIG. 4 shows a schematic overview of a discrete convolution operation;

FIG. 5 is an illustration of a portion of Pascal's triangle;

FIG. 6 is a flow diagram illustrating a forward pass performed by an ISP model of a first embodiment;

FIG. 7 is a flow diagram illustrating a backward pass performed by the ISP model of the first embodiment;

FIG. 8 is a flow diagram illustrating a further stage performed by the ISP model of the first embodiment;

FIG. 9 is a flow diagram illustrating processing during inference performed by an ISP of the first embodiment;

FIG. 10 is a flow diagram illustrating a preparatory stage of a second embodiment;

FIG. 11 is a flow diagram illustrating a method performed during a forward pass by an ISP model of the second embodiment;

FIG. 12 is a flow diagram illustrating a method performed during a backward pass by the ISP model of the second embodiment;

FIG. 13 is a flow diagram illustrating a further stage of the second embodiment; and

FIG. 14 is a flow diagram illustrating a method performed by an ISP of the second embodiment during inference.

### DETAILED DESCRIPTION

Two embodiments are described below with reference to the figures. The embodiments relate generally to configuration of image signal processors (ISPs) with an associated neural network. In particular, the embodiments introduce a method of differentiating filters by the number of times that the filter is applied. As will be explained in more detail below, the introduction of these differentiable filters allows parameters of an ISP to be automatically configured during training of the neural networks.

The neural networks themselves are not described in great detail because the techniques described are of general application to neural networks that can process incoming images from an ISP. Tasks that may be performed by neural networks include, but are not limited to, image recognition, object detection, and image segmentation.

It will be understood that other embodiments are also possible, and that the embodiments described here do not limit the scope of the claims.

### Processor Architecture

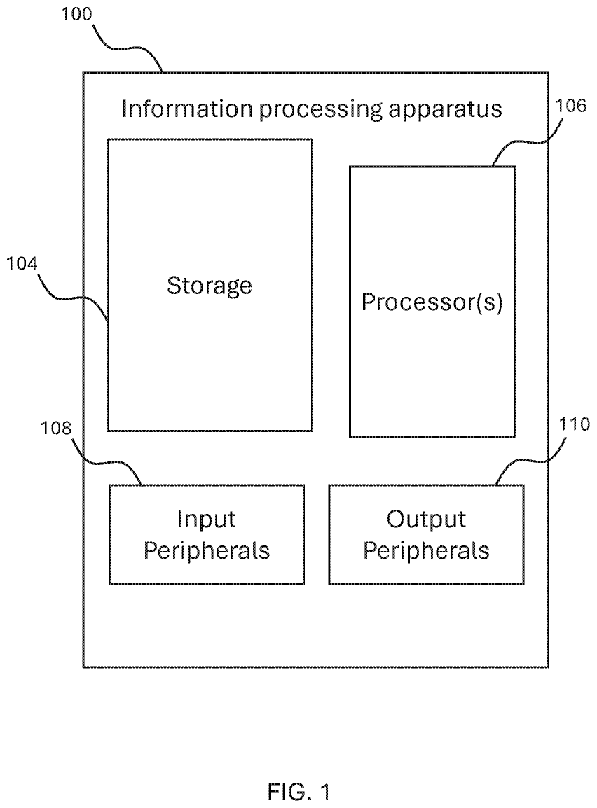

FIG. 1 is a schematic diagram of an information processing apparatus 100. The information processing apparatus may comprise a storage 104, one or more processors 106, input peripherals 108, and output peripherals 110. The storage 104, processor 106, input peripherals 108, and output peripherals 110 may be connected by a bus, which is not shown in FIG. 1.

The storage 110 may be any form of computer memory, such as a solid-state drive. The storage 110 may store data. Data stored in the memory can be accessed by the processor 106. The storage 104 may include components such as random-access memory (RAM), such as static RAM or dynamic RAM, or read-only memory (ROM), such as programmable ROM. The storage 104 may further comprise cache memory to be accessed by the processor(s) 106. The processor(s) 106 may be any form of computer processor, such as a central processing unit (CPU), graphics processing unit (GPU), neural processing unit (NPU) or tensor processing unit (TPU). The processor(s) 106 may include an image signal processor (ISP). The processor(s) 106 may be usable for performing operations commonly used during operation of a neural network, such as multiply-accumulate (MAC) operations.

The information processing apparatus 100 may take many forms. In some examples, the information processing apparatus may be a server, distributed hardware for a cloud service, a computer, a mobile device such as a laptop or mobile phone, an IoT device, a self-driving vehicle etc.

The information processing apparatus 100 in FIG. 1 further comprises input peripherals 108, which may include devices such as microphones, video cameras or other media capture devices. The input peripherals 108 may further include keyboards, mice and/or tactile inputs such as touch screens or touch pads. The input peripherals may include sensors such as optical, vibration or thermal sensors. For instance, optical sensors may quantify lighting conditions in the form of luminance or colour and provide as inputs to the peripherals 108.

The information processing apparatus 100 further comprises output peripherals 110 that may include display components such as LCD screens for displaying output data. In some examples, the output peripherals 110 may connect to external devices that may further process the processed output data provided by the information processing apparatus 100. For instance, external devices may display the processed data or perform actions in response to identifying occurrences or events within the processed data.

As mentioned above, the information processing apparatus 100 may comprise an image signal processor (ISP), which is a specialized hardware component for processing digital image data. An ISP typically comprises an interface for receiving image data, a digital signal processor for performing processing on received digital image data, storage for storing digital image data that has been received, processed or is in an intermediate stage of processing, and a control unit. The ISP may be configured to perform functions such as noise reduction, colour correction and enhancement e.g. an adjustment of white balance or colour space conversion. The ISP may be configured to perform defective pixel correction and/or demosaicing to convert raw image data to other formats by interpolation, tone mapping etc.

Various methods will be described below. Any of these methods may be implemented by one or more computer programs that may be stored on a non-transitory computer-readable storage medium and run on one or more information processing apparatus. In some implementations, the source code for any such program may be written in Python, C, C++, Rust, Julia, etc and may use specific development frameworks, libraries, or packages, including PyTorch, TensorFlow, Keras, CUDA, etc. The examples provided herein for the hardware and software components do not constitute an exhaustive list; many more similar components may be alternatively or additionally included.

In other implementations, features may be implemented in dedicated hardware, such as application specific circuits (ASICs), field-programmable gate arrays, etc.

### Systems for Training a Neural Network

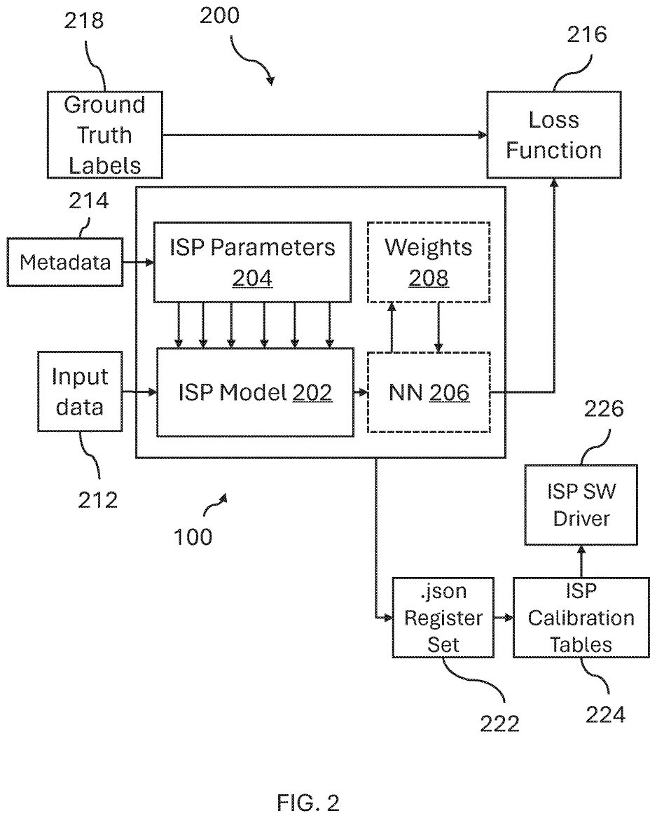

FIG. 2 shows a system 200 for training a neural network 206 and determining parameters of an ISP model 202. The system may alternatively be described as an information processing apparatus. The ISP model may apply a predetermined filter that corresponds to the predetermined filter of an ISP that is to be implemented in hardware. The ISP model is configured to be differentiable with respect to a continuous variable that corresponds to the number of times a predetermined filter is applied. In other implementations, the ISP model 202 may be replaced by an ISP as the model of the ISP may be considered to be a virtual ISP or software ISP.

The neural network 206 is configured to receive processed image data from an ISP model 202. The ISP model 202 takes as input ISP parameters 204 that configure functions of the ISP model 202. The ISP parameters 204 may include a filter to be applied to incoming image data and a number of times that the filter is to be applied to the incoming image data. Correspondingly, the neural network 206 is configured with weights 208 that determine behaviour of the neural network 206.

During training, input data 212 is input to the ISP model 202 for processing. During a forward pass, the ISP model 202 performs processing on the input image data 212 based on ISP parameters 204 and metadata 214 of the input image data 212. Processed image data from the ISP model 202 is then input to neural network 206. The neural network 206 performs inference and outputs a prediction. The output prediction of the neural network 206 is provided to a loss function 216.

During a backward pass, the output prediction is compared by the loss function 216 against ground truth labels 218 to determine a loss corresponding to a difference between a prediction and an expected ground truth label. The losses from the loss function 216 may be sent to visualisation tools such as TensorBoard (not shown). As will be explained in more detail later, losses from the loss function are backpropagated through the neural network 206 and the ISP model 202 so that both the weights 208 and the ISP parameters 204 are updated.

The forward and backward passes are repeated until the weights 208 of the neural network 206 and ISP parameters 204 are determined i.e. the system is trained. Following training of the neural network 206, the trained weights 208, and trained ISP parameters 204 may be output to a json register set 222. Other forms of storing the trained weights 208 and trained ISP parameters 204 may be used, such as a .xml file or a .csv file. The register sets are stored in ISP calibration tables 224, which in turn form part of an ISP software driver 226.

### System for Performing Inference

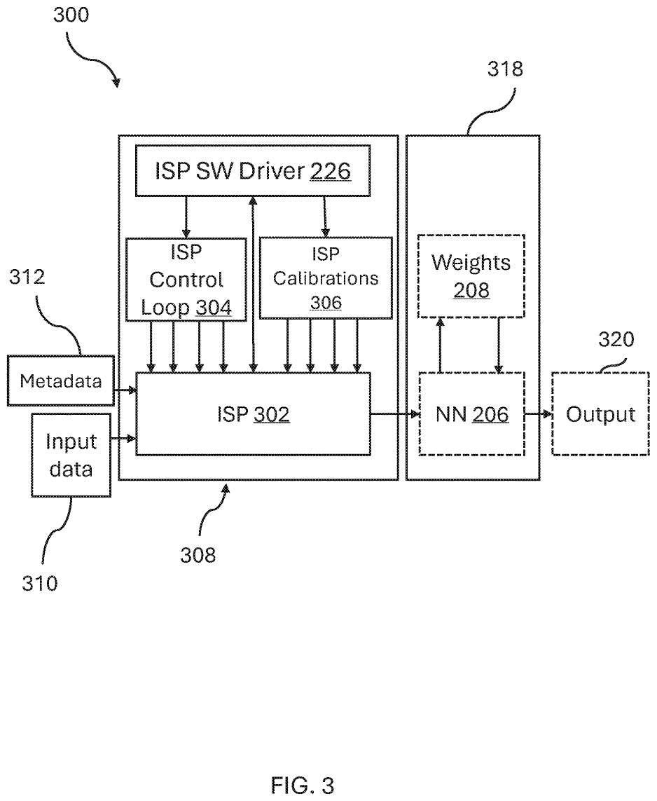

FIG. 3 is a schematic diagram showing a system for performing inference on input data 310 with associated metadata 312. The system comprises an ISP 302. The system further comprises the neural network processing apparatus 318, which comprises the neural network 206 and trained weights 208. The ISP 302 is controlled by the ISP software driver 226. The ISP driver 226 provides ISP calibrations 306 corresponding to trained calibration data from the training stage described in connection with FIG. 2. An ISP control loop 304 is provided to control the ISP 302 in use.

To perform inference, input image data 310 and associated metadata 312 are input to the image signal processor 302. The image signal processor 302 performs image signal processing under the control of the ISP control loop 304 and using the ISP calibrations 306. The ISP 302 applies the filter an integer chosen number of times, as will be described in more detail below. The processed image data is output to the neural network 206. The neural network 206 performs inference using the trained weights 208 to generate an output prediction 320.

The output 320 depends on the nature of the neural network 206. In some examples, the neural network 206 may perform tasks such as image recognition, object detection, depth mapping, image segmentation, etc.

### Convolution Operations

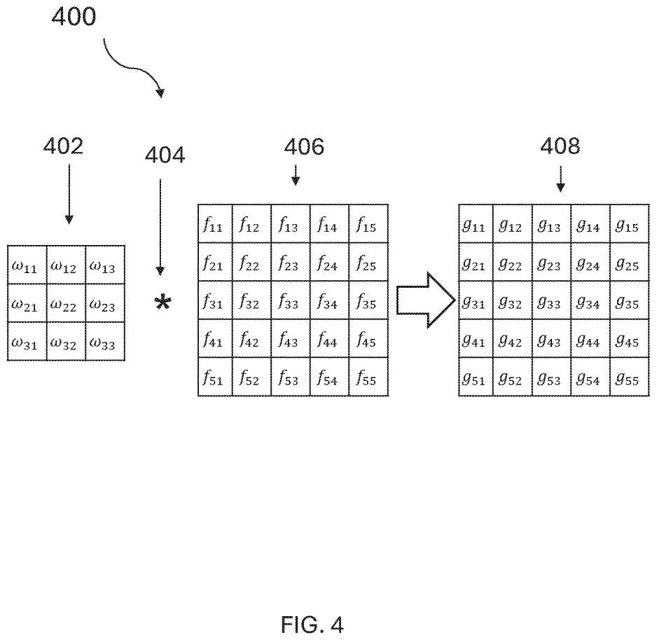

A convolution operation, such as that typically used to apply image filters, is described here with reference to FIG. 4. A convolution operation is an operation that takes two mathematical objects as input and returns a third mathematical object as output. In the context of image processing, a convolution operation typically refers to a discrete convolution operation. A discrete convolution operation may take two matrices as input and returns a third matrix as output. One of the two input matrices may be a matrix of pixel values from image data and the other matrix may be an image filter. The third matrix, i.e. the matrix that is outputted, is typically a matrix of pixel values that have been altered in some way by the application of the image filter (e.g. a smoothed image).

An image filter used in convolution operations typically comprises a kernel. The kernel may be formed of a grid, typically a square, of coefficients. The values of the coefficients vary depending on the function of the filter. Common image filters may be used to control at least one of image sharpness, image blurring, a demosaicing parameter, a denoising parameter, and a white balance parameter. In FIG. 4, the convolution operation 400 takes place with a kernel 402. The image data before the convolution is applied is the input data 406. The convolution operator 404, represented here by a star, produces processed image data 408 as output.

A discrete convolution can be represented by

G=Ω*F

Here, the capital letter ‘G’ is used to represent the output data, the capital letter ‘Ω’ is used to represent the kernel and the capital letter ‘F’ is used to represent the input data. As is common in the art, the asterisk is used to denote a convolution between the kernel 2 and the matrix of input data F. In the context of image filtering, each of the inputted matrices, and the outputted matrices, are typically square.

The process of performing a discrete convolution is now described here. The kernel 402 comprises three rows and three columns. The input data 406 comprises five rows and five columns. The convolution operation proceeds along each entry of the input data to calculate a corresponding each entry of the output data. The kernel 402 comprises entries labelled ω₁₁, ω₁₂, . . . , ω₃₃. Similarly, the input data includes entries labelled f₁₁, f₁₂, . . . , f₅₅. The entries of the kernel 402 and the input data 406 are labelled with indices. The first index corresponds to the row position of the entry and the second index corresponds to the column position of the entry. Note the distinction between the capital letters, which are used here to represent the matrices, and the respective lower case letters, which are used to represent entries within each of the matrices.

As an example, consider the calculation to find the entry g₁₁ of the output data 408. The kernel is centred on the corresponding entry f₁₁ of the input data 406. The result is that some of the entries of the kernel 402 are overlaid onto entries of the input data 406, and other entries of the kernel 402 are not. The other entries of the kernel 402 are said to be ‘overflowing’ the input data. The entries of the kernel 402 that overlay the entries of the input data are each multiplied by the entries of the input data 406 that they overlay. The products are then summed together to obtain the entry of the output data, g₁₁. In this example, the kernel 402 is overlaid on f₁₁ so that f₁₁ is overlaid by ω₂₂, f₁₂ is overlaid by ω₂₃, f₂₁ is overlaid by ω₃₂, and f₂₂ is overlaid by ω₃₃. None of the other entries in the input data 406 are overlaid by any of the kernel 402. The entry 911 is then calculated as g₁₁=f₁₁ω₂₂+f₁₂ω₂₃+f₂₁ω₃₂+f₂₂ω₃₃. The kernel is then shifted over by one square so that the entry ω₂₂ is overlaid on f₁₂, and a similar calculation is performed to calculate g₁₂. The process continues until each term in the output matrix has been calculated. As a further example of the calculations that take place, the entry g₃₃ is calculated as g₃₃₌ω₁₁f₂₂+ω₁₂f₂₃+ω₁₃f₂₄+ω₂₁f₃₂+ω₂₂f₃₃+ω₂₃f₃₄+ω₃₁f₄₂+ω₃₂f₄₃+ω₃₃f₄₄.

The discrete convolution described above may, in some cases, be alternatively labelled as a cross-correlation. In some implementations, the kernel may be flipped about its rows and columns before it is overlaid on the input data. Flipping the kernel about its rows and columns before overlaying the kernel on the input data may occur in situations where the kernel is asymmetric. The operations of the convolution operation—multiplication and addition—may be performed in hardware of the information processing apparatus 100 by multiply-accumulate units.

In some implementations, entries of the kernel 402 that overflow the input data 406 may be included by the summation by some predetermined algorithm. For example, each entry of the kernel 402 that overflows the input data may be multiplied by a fixed value, such as 0.5, and added to the summation of a given entry in the output data.

Commonly used kernels include Gaussian kernels, which are kernels with entries along horizontal or vertical directions that resemble a Gaussian distribution. Gaussian kernels can be used for blurring. Gaussian kernels, and typical values of a Gaussian kernel, are known in the art and so are not described here. Other kernels may include kernels that are used for sharpening, or other image processing uses. For example, kernels may be used for controlling at least one of image sharpness, image blurring, a demosaicing parameter, a denoising parameter, and a white balance parameter.

### First Embodiment

### Binomial Filters

In the first embodiment, the ISP 302 uses a binomial filter. A binomial filter is a filter that that has coefficients that follow a binomial distribution. For example, the binomial filter may be (1,2,1). Each of the terms in the binomial filter may be multiplied by a respective pixel value in the input data to produce output data. The relative magnitude of the terms of the binomial filter may be interpreted as weights. The weights may be used as part of a weighted sum to combine terms from adjacent pixel values.

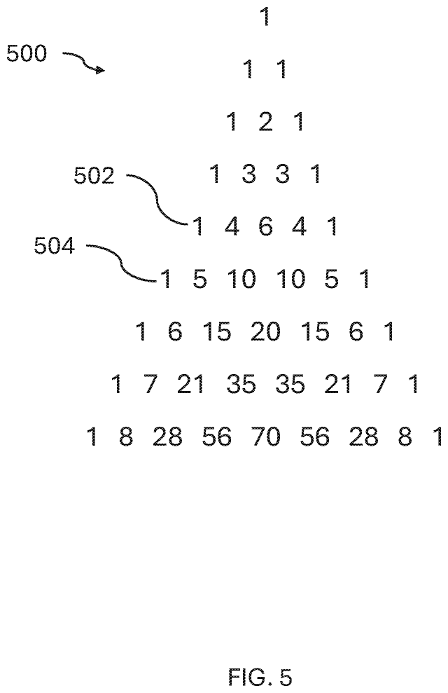

An example of a binomial filter applied to a one-dimensional line of pixels is provided here and with reference to FIG. 5. It will be appreciated that the example given is one dimensional for reasons of ease of understanding: the binomial filter could be applied to a two-dimensional grid of pixels by applying a first binomial filter in a first dimension and a second binomial filter in a second dimension.

Rows of coefficients from binomial filters may be used to form Pascal's triangle. A portion of Pascal's triangle (which may be referred to for ease as ‘triangle’) 500 of FIG. 5 comprises rows of one-dimensional kernels. The numbers correspond to entries in the kernel. The value of each of the numbers corresponds to the intensity of the kernel entry that they represent. Each row of pixels in FIG. 5 forms a one dimensional line of length n. Each pixel in a row is given a position, x, from 0 to n−1. Neighbouring pixels in the same row are labelled consecutively.

How the triangle 500 is obtained is described here. The first (top) row of the triangle can be considered to be the initial row of the triangle. The first row of Pascal's triangle is the entry ‘1’. There is only one entry in the first row of the triangle that is non-zero. Other entries in the first row, while now shown, can be considered to be equal to zero. The second row of Pascal's triangle is obtained from the first row. Entries in the second row of Pascal's triangle are offset from the first row by a spacing of one-half an entry of the top row. Accordingly, each entry in the second row is equally spaced from two entries in the row above. Each entry in the second row can be calculated as the sum of each of the two closest entries in the row above. For example, the leftmost entry in the second row is closest to the entry in the first row, which is equal to 1, and an empty space to the left of the value 1, which is considered to be set to zero. The leftmost entry in the second row can thus be calculated as the sum of 1 and zero, which is 1. Similarly, the rightmost entry in the second row is closest to the entry to the first row, which is equal to 1, and an empty space to the right of the value 1, which is considered to be zero. The rightmost entry in the second row can thus be calculated as the sum of 1 and zero, which is 1.

A further example is provided with reference to the fifth row 502 of the triangle 500, and the sixth row 504 of the triangle 500. The leftmost entry in the sixth row 504 is the sum of the two entries 1 and zero which are closest above, as before, so is set equal to their sum, which is 1 plus zero which equals 1. The second entry in the sixth row 504 is the sum of 1 and 4, so is equal to 5. The third entry in the sixth row 504 is the sum of 4 and 6, so is equal to 10. Each term in the third row continues to be calculated in this way until the calculated value of an entry is zero, at which point the row is considered to be finished and calculation of the next row can proceed.

As the number of entries in a row of the triangle 500 increases, the distribution of entries along a row tends towards a Gaussian distribution. This is a consequence of the central limit theorem, which states that repeated application of a distribution centred on a point will, after enough applications, produce a distribution that tends towards a Gaussian distribution. Accordingly, repeated application of a binomial filter can be used to approximate a Gaussian kernel. Binomial filters are efficient to implement because the calculations needed to apply the binomial filter are multiplication and accumulation, which are computationally cheap to implement on hardware such as multiply-accumulate unit(s).

In particular, an example of the binomial filter is the binomial filter (1, 2, 1). The binomial filter (1,2, 1) is computationally cheap to implement because multiplication can be implemented by bit-shifting binary values, which is computationally simple. Every other row of the triangle 500 can be obtained by repeated application of the binomial filter (1,2, 1). The binomial filter (1, 2, 1) is symmetric about the centre entry. The binomial filter (1, 2, 1) is said to be ‘odd’ because it has three kernel values, and three is an odd number.

Another example of the binomial filter is the binomial filter (1, 1). The binomial filter (1, 1) uses one accumulate operation per pixel coefficient value and so is also computationally cheap to implement.

### Determining a Derivative of a Binomial Filter

A feature of the method of the first embodiment is that the ISP model can obtain a derivative of a filter to be applied to image data with respect to the number of times that the filter is applied to the image data. In other words, the aim is to determine a rate of change of image data with respect to subsequent applications of the filter.

In general, this is a difficult problem. However, in the case of binomial filters, the filter can be approximated by a continuous distribution. The continuous distribution can be differentiated with respect to the number of applications of the filter as will be explained below.

A derivative of a Filter, F, with respect to a number of applications, n, depends on both the position at which the filter is applied, x, and the number of applications of the filter, n. Here x and n represent position and number of applications of the discrete filter and x′ and n′ represent continuous variable (parameterized) equivalents. w(n′) represents a continuous variable that maps to the size of the kernel, and is a function of n′. In other words:

$${F}_{n} ( x ) \approx G ( {x}^{′} ; {n}^{′} ) ∼ \frac{1}{σ \sqrt{2 π}} {e}^{- \frac{{( m )}^{2}}{2 {σ}^{2}}}$$

$$where$$

$$m = {x}^{′} - w / 2$$

$$σ = f ( {n}^{′} )$$

Note that integer values of w may map to the order of the binomial filter, i.e. the row of the triangle 500 that repeated application of the binomial filter corresponds to. The w/2 term denotes that the mid-point of the distribution is always the middle of the kernel as can be seen from FIG. 5. The continuous variable w may correspond to the width of the kernel that corresponds to repeated applications of the filter.

There may be a relation between the continuous variables n′ and w. For example, in the case of the binomial filter (1, 2, 1), w may be obtained as w=2n′+1. In a case that other binomial filters are applied, the relation between the continuous variables w and n′ may be different. Accordingly, the above equation approximates the binomial filter. In some implementations, a relation between w and n′ may be obtained using lookup tables. The expression σ=f(n′) denotes that σ is, in general, a function of the continuous variable n′. In some examples, o may be obtained as

$$σ = \frac{\sqrt{w}}{2} ,$$

where w is a function of the continuous variable n′. In some examples, w may be obtained as w=2n′+1, as described above.

Once a Gaussian function has been determined that corresponds to a number of applications of the binomial filter, which may be the binomial filter (1, 2, 1), the derivative with respect to the number of applications of the filter may be determined analytically or using numerical methods by differentiating the above equation with respect to n′. The calculation of the derivative with respect to the number of applications of the filter may be performed using any suitable method and may be provided by a software framework. Calculating the derivative of a Gaussian filter is well known in the art, and further details are not provided here.

In some implementations, obtaining an approximation to a repeated application of a filter could proceed using a different distribution, such as a Poisson distribution.

### Forward Pass

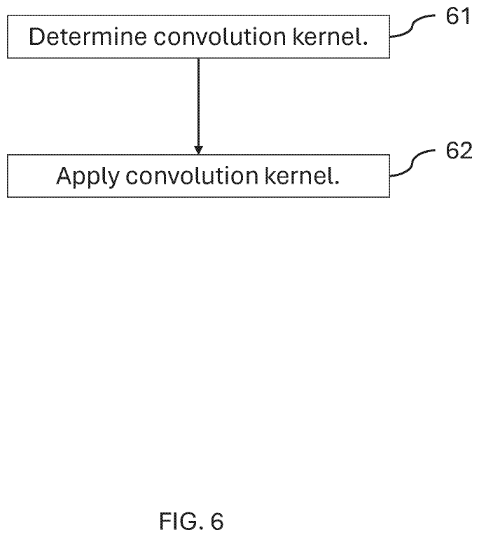

A method of the first embodiment is now described here with reference to FIGS. 6 to 9. The method that is performed as part of the first embodiment makes use of the properties of binomial filters described above. The filter may be a binomial filter, such as (1, 2, 1) described above. Multiple applications of the filter are equal to a binomial filter of a particular order as shown in FIG. 5 and may be approximated by a Gaussian distribution.

The system 200 of FIG. 2 is implemented in which the weights of the neural network 208 and the ISP parameters 204 are being determined during training. The ISP parameters 204 in this example include the number of times to apply the binomial filter in order to smooth incoming image data prior to processing by the neural network 206.

The training proceeds in two phases. The first phase is a forward pass in which input data 212 and metadata 214 are input and processed by the ISP model 202 and neural network 206. A prediction is made which is processed by the loss function 216 by comparison to the ground truth labels 218.

During the forward pass, the neural network 206 processes the input data in accordance with the configuration of the neural network 206. The type of the neural network 206 will depend upon the applications, but could, for example, be a neural network 206 for performing object recognition.

A second phase, described further below, is a backward pass in which the weights 208 of the neural network are updated and the ISP parameters are updated. In particular, the number of times that the binomial filter is applied to the input image data 212 may be updated.

The processing performed by the ISP model 202 during the forward pass is described with respect to FIG. 6. The ISP parameters 204 take a current value that will be updated during training. In particular, one of the ISP parameters 204 is a current value of the number of times that the binomial filter is currently being applied to input image data 212. Instead of the number of times n that the binomial filter is being applied, the continuous variable n′ may be used as an ISP parameter 204. The continuous variable n′ is a real number and may or may not take an integer value.

In step 61, the binomial filter is parameterised with a continuous Gaussian distribution. The Gaussian distribution can be described in terms of its standard deviation σ, which as explained above depends on the number of times the filter is applied, n.

A one-dimensional Gaussian distribution G(x′; σ) takes the form

$$G ( {x}^{′} ; σ ) ∼ {e}^{- \frac{{( m )}^{2}}{2 {σ}^{2}}} ,$$

where m=x′−w/2 and w=w(n′). The term x′, as used here, is a continuous value that forms a distribution that approximates the discrete kernel entries that actually arise from repeated application of the filter. The expression w=w(n′) means that w is a function of n′, as described above. The continuous variable w may correspond to the width of the kernel that corresponds to repeated application of the filter. Integer values of the continuous value x′ correspond to entries of the kernel (from FIG. 5), which are integer. The standard deviation σ refers to a value that characterises the spread of the Gaussian distribution. The standard deviation σ may, in general, be a function of the continuous variable n′. The Gaussian distribution may be normalised by the use of a pre-factor term. Details of how the standard deviation relates to the Gaussian distribution are well known in the art and are not described further here. The w/2 term denotes that the mid-point of the Gaussian distribution is always the middle of the kernel. Accordingly, the expression m=x′−w/2 describes applying an offset to the Gaussian distribution so that the mid-point of the Gaussian distribution is always the middle of the kernel.

In another example, repeated application of a two-dimensional binomial filter will generate a two-dimensional kernel that can be approximated by a continuous two-dimensional Gaussian distribution

$$G ( {x}^{′} , {y}^{′} ; {σ}_{x} , {σ}_{y} ) ∼ {e}^{- [ \frac{{( m )}^{2}}{2 {σ}_{x}^{2}} + \frac{{( p )}^{2}}{2 {σ}_{y}^{2}} ]} ,$$

where m=x′−wₓ/2 and p=y′−w_{y}/2. The continuous variable wₓ may correspond to the width of the kernel that corresponds to repeated application of the filter in the x-direction. Here wₓ=wₓ(n′), which means that wₓ is a function of n′. The continuous variable w_{y} may correspond to the width of the kernel that corresponds to repeated application of the filter in the y-direction. Similarly w_{y}=w_{y}(n′), which means that w_{y} is a function of n′. As above, the term x′ is a continuous distribution that forms a distribution over one dimension of the kernel entries. Integer values of the continuous value x′ correspond to entries of the kernel. The term y′ is a continuous distribution that forms a distribution over the other dimension of the kernel entries. Integer values of the continuous value y′ corresponds to entries of the kernel. The wₓ/2 and w_{y}/2 terms denote that the mid-point of the Gaussian distribution is always the middle of the kernel. Accordingly, the expressions m=x′−wₓ/2 and p=y′−w_{y}/2 describe applying an offset to the Gaussian distribution so that the mid-point of the Gaussian distribution is in the middle of the kernel. The standard deviation σₓ refers to a value that characterises the spread of the Gaussian distribution over a dimension that corresponds to the dimension of the continuous value x′. The standard deviation σ_{y} refers to a value that characterises the spread of the Gaussian distribution over a dimension that corresponds to the dimension of the continuous value y′. The standard deviations σₓ and σ_{y} may, in general, be a function of the continuous variable n′. It can be seen from the structure of the Gaussian distribution in two dimensions that the distribution is separable in the continuous value x′ and the continuous value y′. Accordingly, each of the continuous values x′ and y′ can be treated as separate distributions. In some cases, the standard deviation σₓ may equal the standard deviation σ_{y}, and so the Gaussian distribution can be rewritten as

$$G ( {x}^{′} , {y}^{′} ; σ ) ∼ {e}^{- \frac{[ {( m )}^{2} + {( p )}^{2} ]}{2 {σ}^{2}}} ,$$

where the standard deviation σ corresponds to both the standard deviation σₓ described above and the standard deviation σ_{y} described above. In such a case, wₓ=w_{y}=w, where w corresponds to both wₓ and w_{y}. Also in such a case, the standard deviation σ may be a function of the continuous variable n′. Subsequent descriptions will refer to a two-dimensional Gaussian filter with a standard deviation σ. However, the method could similarly be applied to two-dimensional Gaussian distributions with two standard deviations σₓ and σ_{y}, or to one-dimensional Gaussian distributions with a standard deviation σ.

As explained further above, the Gaussian distribution corresponding to a particular number of applications of a filter has a standard deviation that depends on the number of applications of the filter. As can be seen from the form of the Gaussian distribution, the value of the Gaussian distribution decreases as the distance from the centre of the Gaussian distribution increases. Coefficients of the kernel that are more than a determined distance from the centre of the Gaussian distribution, for example three standard deviations or five standard deviations, may be set to zero due to their small magnitude relative to coefficients that are closer to the centre of the Gaussian distribution.

To determine the kernel corresponding to the currently stored value of n′, one of two methods is applied. From an arbitrary value of the continuous variable, n′, it may be possible to round to the nearest integer to obtain an order to the binomial filter. The binomial filter of that order is then selected. Alternatively, a look-up table may be used that maps ranges of the standard deviation, o, or numbers of applications of the filter, n′, to particular binomial filters. The relationship between the standard deviation, o, and the numbers of applications of the filter, n′, was given further above.

In Step 62 the ISP model 202 applies the convolution kernel determined in step 61 to input image data 212 during the forward pass. The input image data 212 takes the form of a matrix of pixel values, as described above. The convolution kernel is applied to the input data in a convolution operation, as is described in the description of a convolution operation in association with FIG. 4. A Gaussian convolution kernel may apply a blurring function to an image by eliminating high frequency components of the input data.

### Backward Pass

During the backward pass (sometimes referred to as backpropagation) of the training phase, weights 208 of the neural network are updated and the ISP parameters 204 are updated. As the ISP parameters relate to processing that precedes the input layer to the neural network 206, the ISP parameters 204 can be seen as parameters of a layer preceding the input layer of the neural network 206. Backpropagation through the neural network 206 is well known in the art and the description below will accordingly focus on features relating to the updates at the ISP model 202.

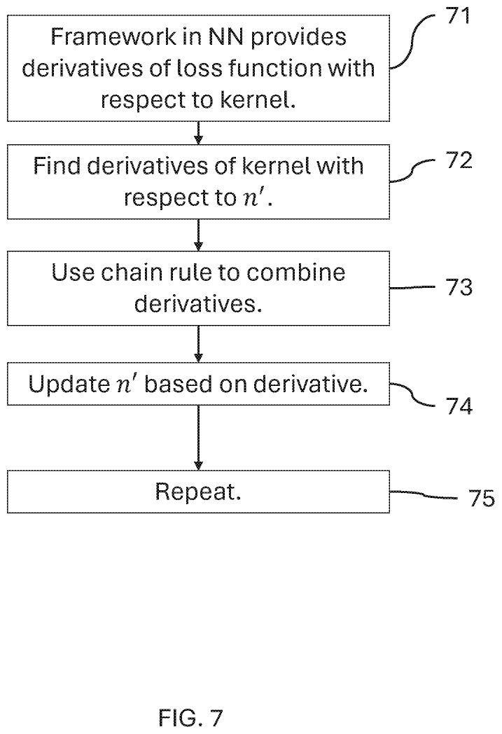

FIG. 7 describes steps performed by the ISP model 202. The steps of FIG. 7 are sometimes referred to as a backward pass. The steps of FIG. 7 refer to steps taken to find an updated number of times to apply a filter. To determine the updated number of times to apply the filter, the method aims to minimise the loss function 216. To minimise such a loss function 216, the system 200 seeks gradients of the loss function with respect to the number of times the filter is applied. The filter can then descend down gradients to find local minima using a gradient descent algorithm, such as stochastic gradient decent, ADAM, etc. A local minimum determined in this way may correspond to the global minimum and therefore minimise the loss function. Gradient descent is well known in the art and as such is not described further here.

More details of the gradient that is sought by the system 200 is provided here. Consider a loss function E and the continuous variable n′ corresponding to the number of times that the filter is applied by the ISP 302. Whole number values of the continuous variable n′ correspond to the number of times the filter can be applied, n. Accordingly, as explained earlier, the continuous variable n′ can be considered to be an extension of the discrete values n over the space of continuous numbers.

The derivative of the loss function E with respect to the continuous variable n′ can be written as

$$\frac{d E}{d {n}^{′}} = \frac{d E}{d K} \frac{d K}{d {n}^{′}} = \frac{d E}{d {k}_{11}} \frac{d {k}_{11}}{d {n}^{′}} + \frac{dE}{d {k}_{12}} \frac{{dk}_{12}}{d {n}^{′}} + … + \frac{d E}{d {k}_{i j}} \frac{d {k}_{i j}}{d {n}^{′}} + … + \frac{dE}{d {k}_{l l}} \frac{{dk}_{ll}}{d {n}^{′}}$$

using the chain rule of calculus. Here, K is used to generally represent the kernel. Accordingly, the portion of the equation

$$\frac{d E}{d {n}^{′}} = \frac{d E}{d K} \frac{d K}{d {n}^{′}}$$

shows that the rate of change of the loss function E with respect to the continuous variable n′ is given by a product of the rate of change of the loss function E with respect to the kernel K and the rate of change of the kernel K with respect to the continuous variable n′. The expression can be further expanded to cover each of the terms within the kernel.

The terms increment from 1 to l in each dimension, which shows that the kernel has l rows and l columns. For a kernel of l rows and l columns, there are l×l=l² entries and so l² terms in the full expansion of the chain rule. A general entry in the kernel K can be represented by kᵢⱼ, where the indices i and j refer to the row and column position of the entry respectively. The indices i and j can each take values between 1 and l. The expression on the right-hand side of the equation above therefore represents expanding the chain rule over each of the entries in the kernel K.

The one-dimensional filter example given with respect to FIG. 4 can be trivially obtained by letting j take just one value.

Each term in the expression on the right-hand side of the equation is a product of a first term and a second term. The first term is of the general form

$$\frac{d E}{d {k}_{i j}} .$$

The second term is of the general form

$$\frac{d {k}_{i j}}{d {n}^{′}} .$$

(By ‘general’, what is meant is that the indices i and j could be substituted for an entry in any position in the kernel K.)

The first term

$$\frac{d E}{d {k}_{i j}}$$

is the loss attributable to the application associated with each coefficient of the kernel (binomial filter) applied to each image pixel value during the forward pass and is obtained by backpropagation from the neural network 206 by treating application of the kernel (binomial filter values) as a layer in the network. The second terms are obtained by the ISP model 202 of the training system 200. Once both terms are determined, it is possible to determine the overall value

$$\frac{d E}{d {k}_{i j}}$$

to allow gradient descent for updating n′. FIG. 7 is a flow chart describing the calculation of the second terms.

In step 71 describes the neural network of the neural network system providing the gradients

$$\frac{d {k}_{i j}}{d {n}^{′}}$$

from backpropagation or error through the neural network 206.

In step 72 the gradients

$$\frac{d E}{d {n}^{′}}$$

are determined. In the case that the filter is described by a Gaussian distribution, the gradient for each kernel value can be found analytically using the equations given above. The exact form of the derivative of a Gaussian distribution with respect to the continuous variable n′ (or the derivative of a Gaussian distribution with respect to the standard deviation σ in implementations where the standard deviation is used) depends on any normalisation of the Gaussian distribution, which may also be a function of the standard deviation σ. However, the derivative at each position in the kernel can be can be calculated using standard mathematical techniques in advance of implementation.

At step 73 the gradients of the kernel calculated in step 72 are combined in accordance with the chain rule mentioned earlier. Each of the calculated gradients, which respectively corresponds to a gradient of one of the kernel entries with respect to the continuous variable n′, is multiplied by a gradient of the loss function with respect to the respective kernel. The resultant sum provides the rate of change of the loss function E with respect to the continuous variable n′.

In step 74, the continuous variable n′ is then incremented in the direction that reduces the error function E based on the gradient determined in step 73. The size of the increments may depend on parameters such as the learning rate of the training and the steepness of the gradient determined in step 73. If there is no increment of the continuous variable n′ that reduces the error function E, or the error function E is determined to have satisfied an exit criteria, then the value of the continuous variable n′ that minimises the error function E may be determined to have been found, and the method may output the obtained value of the continuous variable n′. The exit criteria may include, for example, determining that the error function E is below a bound value.

The obtained continuous variable n′ is assigned the label

$${n}_{chosen}^{′} .$$

If there is an increment of the continuous variable n′ that reduces the error function E determined in accordance with a gradient descent method, then the continuous variable n′ is incremented by that amount. The steps of FIG. 7 subsequently repeat with the updated value of the continuous variable n′.

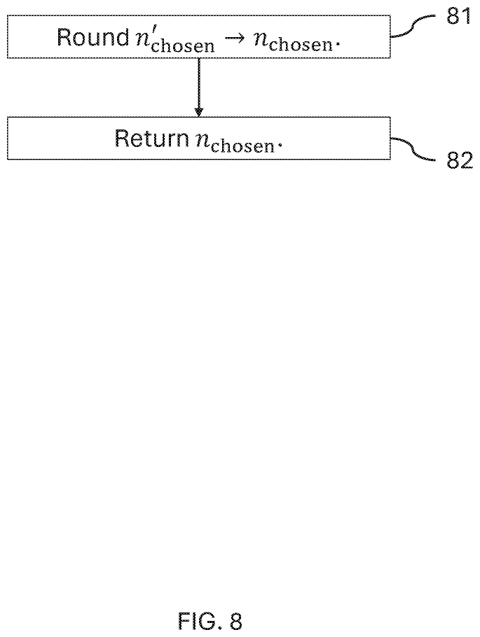

FIG. 8 describes the steps that take place after the steps of FIG. 7 have output the chosen continuous variable

$${n}_{chosen}^{′}$$

Step 81 involves mapping the chosen continuous variable

$${n}_{c h osen}^{′}$$

to a corresponding chosen integer value n_{chosen}. The chosen continuous variable

$${n}_{chosen}^{′} .$$

may be rounded to obtain the corresponding chosen integer value n_{chosen}. For example, the corresponding chosen integer value may be the closest integer value to the chosen continuous variable. Alternatively, other rounding schemes may be used. For example, the chosen continuous variable could be rounded upwards to obtain the corresponding chosen integer value, or the chosen continuous variable could be rounded downwards to obtain the corresponding chosen integer value. In other implementations, the chosen continuous variable could be multiplied by a scale factor to obtain the corresponding chosen integer value. In general, any suitable mapping between the chosen continuous variable

$${n}_{chosen}^{′}$$

and the chosen integer value n_{chosen} could be used.

Step 82 involves outputting the corresponding chosen integer value n_{chosen}. The corresponding chosen integer value n_{chosen} may be written into the memory of the image signal processor as described in connection with FIG. 2. The chosen integer value n_{chosen} may be alternatively be called the chosen number of applications (of the predetermined filter), or the chosen integer number of applications (of the predetermined filter).

### Inference

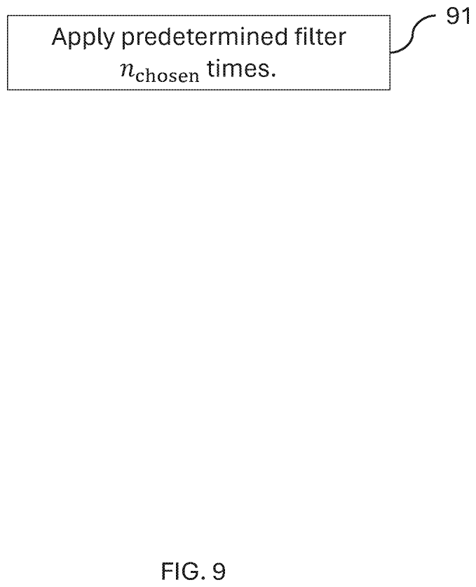

FIG. 9 describes a method that takes place when the image signal processor 302 is used for inference, described previously with respect to FIG. 3. The image signal processor 302 may receive the value n_{chosen} from the training process just described. The image signal processor may be in use in any circumstance where inference of image data takes place using the ISP 302 and trained neural network 206.

In step 91, the predetermined filter is applied to input data 310 n_{chosen} times. Note that the actual filter may be applied rather than the continuous approximation represented by the Gaussian function.

The predetermined filter of the first embodiment can be applied using dedicated circuitry of the ISP 302. Accordingly, the filter can be applied to input data efficiently. The binomial filter may multiply input data by bit-shifting the input data. After the predetermined filter is applied to input data n_{chosen} times, the data can further be sent to the neural network processing apparatus 318. The neural network processing apparatus 318 applies the trained neural network 206 as described previously in connection with FIG. 3.

The neural network processing apparatus 318 may be used for computer vision purposes. For example, consider a scenario in which an image signal processing apparatus 308 and neural network processing apparatus 318 are implemented in a self-driving vehicle, such as a self-driving car. The input data may be image data from an image sensor on the exterior of the car. For example, the image data may be from an image of the surroundings of the car. The image signal processing data could process the input data by applying the filter the integer chosen number of times so that the neural network processing apparatus is able to more effectively identify objects such as pedestrians, street furniture or other cars in the field of view of the self-driving car.

The above-described method enables image signal processing to take place more efficiently because a number of times to apply a binomial filter can be determined in the training stage of a neural network in a way that optimizes the value for a particular application. Making the kernel differentiable with respect to the number of times the filter is applied provides an efficient way of determining a chosen number of times to apply the filter as described above.

### Second Embodiment

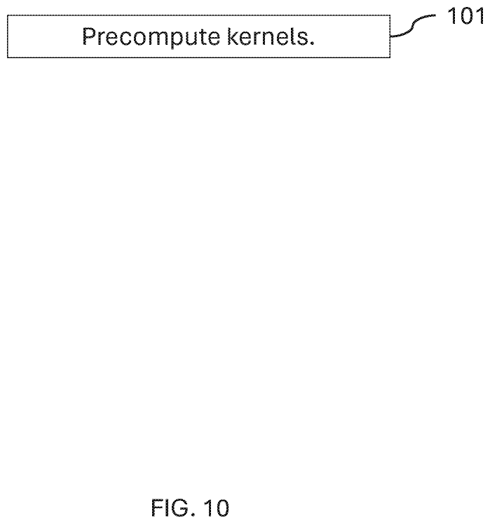

A method of a second embodiment is now described here and with reference to FIGS. 10 to 14. The first embodiment focused on the application of binomial filters. While the second embodiment may be applied to a binomial filter, the second embodiment is applicable to filters that may correspond to more general filters than just those that correspond to a Gaussian distribution.

The description of FIGS. 2 and 3 apply equally to the second embodiment. The differences between the second embodiment and the first embodiment will now be described and relate to how the derivative of the filter with respect to the number of times that the filter is applied is determined. The other details of the first embodiment relating to the forward pass and backward pass remain the same and are not repeated.

FIG. 10 shows steps of an initialisation stage of the second embodiment. As noted above, the processing applied by the ISP 302 relates to applying a predetermined filter a number of times. The filter may be a blurring filter, a sharpening filter, a filter relating to white balance, etc.

Step 101 involves precomputing a plurality of kernels that are to be used in the method of the second embodiment. The kernels may be computed by applying the predetermined filter repeatedly to generate kernels of different orders (similar to the different orders of binomial filter described with respect to FIG. 4). For example the kernel of order 1 corresponds to a single application of the predetermined filter. The kernel of order 2 corresponds to two applications of the predetermined filter. In general, the kernel of order T, corresponds to T applications of the predetermined filter.

Each time the filter is applied, a ‘compound’ filter is produced that results from applying the filter a plurality of times. Each of these ‘compound’ filters are recorded and are the kernels that correspond to applying the predetermined filter each time of a plurality of number of times. Each of the precomputed kernels are stored in a lookup table (LUT). The LUT may be accessible by the processing components of the image signal processor.

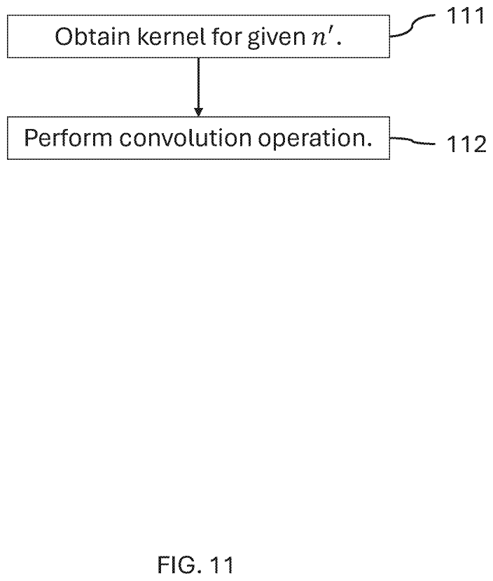

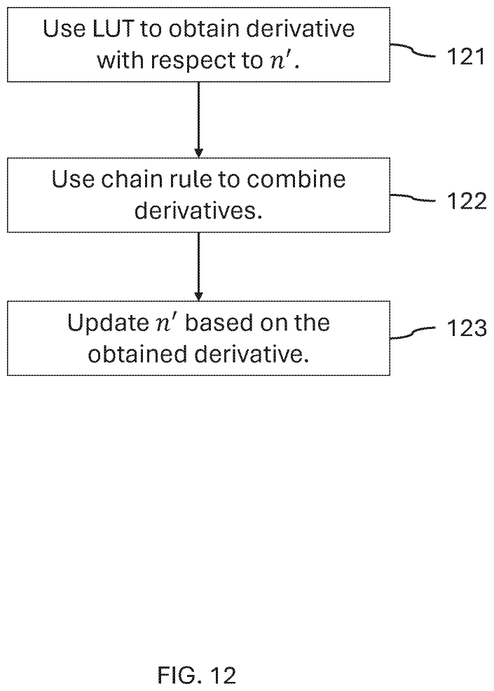

FIG. 11 describes steps of a forward pass performed by the ISP model 202 and FIG. 12 describes steps of a backward pass performed by the ISP model 202. After performing the steps of FIG. 11 and FIG. 12, a gradient with respect to a given number of times the filter is applied will be outputted. The kernels are parameterized from a discrete number of applications of the filter, n, to a value of a continuous variable n′ that is stored in the ISP parameters 204 of the ISP model 202 as described previously. As in the first embodiment, integer values of the continuous variable n′ correspond to applying the predetermined filter a discrete number of times. However, in this example, n′ is not associated with an analytic function, such as the Gaussian distribution described in the first embodiment.

Step 111 describes obtaining the kernel for the value of the continuous variable n′. To obtain the relevant kernel, the continuous variable is first rounded to an integer value n. As in the first embodiment, the continuous variable could be rounded to the integer value using any suitable rounding scheme. For example, the continuous variable could be rounded to the nearest integer. Alternatively, the continuous variable could be rounded up to the next integer or rounded down to the next integer. Once the integer value corresponding to the continuous variable has been obtained, the kernel K corresponding to the integer value is obtained by finding the kernel K that corresponds to applying the filter the predetermined number of times in the LUT.

Once the kernel K that corresponds to the integer value n is obtained, the kernel K is applied to the input data in step 112. Applying the kernel K to the input data comprises performing a convolution between the kernel K and the input data as described in FIG. 4 and accordingly is not described further here.

FIG. 12 describes a backwards pass that is performed by the ISP model 202. The steps of FIG. 12 may be described as a backwards pass because the gradients are obtained for the kernels that were obtained in FIG. 11. In step 121, the LUTs are used to obtain a derivative of the kernel K. The derivative of the kernel K may be obtained by interpolating between successive kernel values corresponding to adjacent orders of kernel in the LUT. A method of interpolating between successive kernel values in the LUT is described here. However, any other suitable method of interpolating between kernel values in the LUT may also be implemented to obtain a gradient of the LUT with respect to the continuous variable n′.

The derivative of the kernel

$$\frac{d K}{d {n}^{′}}$$

may be found by interpolating between values of the kernel in the LUT. A derivative of a general entry kᵢⱼ in the kernel K may be found with the formula:

$$\frac{d {k}_{i j}}{d {n}^{′}} = {k}_{ij , LUT} [ floor ( {n}^{′} ) + 1 ] - {k}_{ij , LUT} [ floor ( {n}^{′} ) ]$$

In the above formula, the term

$$\frac{d {k}_{i j}}{d {n}^{′}}$$

refers to the derivative of the general entry kᵢⱼ of the kernel K with respect to the continuous variable n′. The term K_{ij,LUT}[floor (n′)+1] refers to the general entry kᵢⱼ of the kernel in the LUT that corresponds to the rounded-up value of the continuous variable n′. The term K_{ij,LUT}[floor (n′)] refers to the general entry kᵢⱼ of the kernel in the LUT that corresponds to the rounded down value of the continuous variable n′. Accordingly, the above formula is a difference between a kernel entry that corresponds to a rounded-up value of the continuous variable n′ and a kernel entry that corresponds to a rounded down value of the continuous variable n′.

The above formula corresponds to linearly interpolating between consecutive kernels in the LUT. Taking a difference between kernel values in successive kernels in the LUT corresponds to the gradient of the kernel entry with respect to the continuous variable because the difference in the continuous variable between successive kernel entries is equal to one. Accordingly, the difference between the successive kernel entries corresponds to a gradient with respect to the continuous variable n′. As expected with a linear approximation, the derivative is constant for values of n′ falling between two successive integer numbers of applications of the filter.

Alternative formulas for interpolating between kernels in the LUT may be used. For example, the image signal processor may linearly interpolate between a kernel before the kernel of interest and a kernel after the kernel of interest, and divide the obtained difference by two to obtain an average gradient. Non-linear interpolation methods could also be used.

In some implementations, a normalisation condition may be enforced on the coefficients of the kernel. For example, there may be a constraint imposed that the coefficients of the kernel sum to one, or a constrain that the coefficients of the kernel sum to zero. Alternatively, there may be a constraint that the edges of the kernel satisfy a particular value or set of values. In such scenarios, the derivative of a coefficient of the kernel with respect to the number of applications of the filter may also depend on nearby coefficients and their derivatives, and so the calculation of the derivative of each coefficient may be more complicated than the steps described above. Calculation of the derivative of each coefficient of the kernel in scenarios where a normalisation condition is enforced may be carried out by a suitable software package. Details of the calculating a derivative in such scenarios is well known in the art and further details are not provided here.

As described above, step 121 involves obtaining a derivative of each entry kᵢⱼ in the kernel K with respect to the continuous variable n′. In step 122, each of the derivatives are combined to obtain a derivative of the loss function E with respect to the continuous variable n′. As in the first embodiment, the derivative of the loss function E with respect to the continuous variable n′ is obtained using the formula

$$\frac{d E}{d {n}^{′}} = \frac{d E}{d K} \frac{d K}{d {n}^{′}} = \frac{dE}{d {k}_{11}} \frac{{dk}_{11}}{{dn}^{′}} + \frac{dE}{d {k}_{12}} \frac{{dk}_{12}}{{dn}^{′}} + … + \frac{dE}{d {k}_{i j}} \frac{{dk}_{i j}}{{dn}^{′}} + … + \frac{dE}{d {k}_{m m}} \frac{{dk}_{m m}}{{dn}^{′}} .$$

Each of the calculated gradients determined in step 121, which respectively corresponds to a gradient of one of the kernel entries with respect to the continuous variable n′, is multiplied by a gradient of the loss function with respect to the respective kernel coefficient. The resultant sum provides the rate of change of the loss function E with respect to the continuous variable n′.

In step 123, the continuous variable n′ is then incremented in accordance with a gradient descent scheme in the direction that reduces the error function E. The size of the increments may depend on parameters such as the learning rate of the training and the steepness of the gradient determined in step 122. If there is no increment of the continuous variable n′ that reduces the error function E, or the error function E is determined to have satisfied an exit criteria, then the value of the continuous variable n′ that minimises the error function E may be determined to have been found, and the method may output the obtained value of the continuous variable n′. The exit criteria may include, for example, determining that the error function E is below a bound value.

As in the first embodiment, the obtained continuous variable n′ is assigned the label

$${n}_{chosen}^{′} .$$

If there is an increment of the continuous variable n′ that reduces the error function E, then the continuous variable n′ is incremented by that amount. The steps of FIGS. 11 and 12 subsequently repeat with the updated value of the continuous variable n′.

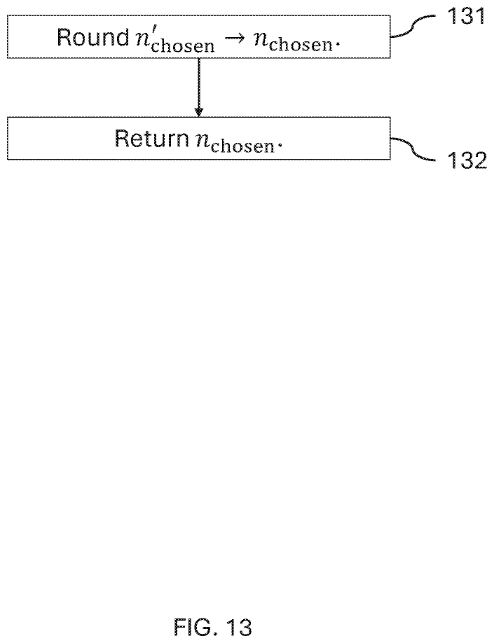

FIG. 13 describes the steps that take place after the steps of FIG. 12 have outputted the chosen continuous variable

$${n}_{chosen}^{′} .$$

Step 131 involves mapping the chosen continuous variable

$${n}_{chosen}^{′}$$

to a corresponding chosen integer value n_{chosen}. The chosen continuous variable

$${n}_{chosen}^{′}$$

may be rounded to obtain the corresponding chosen integer value n_{chosen}. For example, the corresponding chosen integer value may be the closest integer value to the chosen continuous variable. Alternatively, other rounding schemes may be used. For example, the chosen continuous variable could be rounded upwards to obtain the corresponding chosen integer value, or the chosen continuous variable could be rounded downwards to obtain the corresponding chosen integer value. In other implementations, the chosen continuous variable could be multiplied by a scale factor to obtain the corresponding chosen integer value. In general, any suitable mapping between the chosen continuous variable

$${n}_{chosen}^{′}$$

and the chosen integer value n_{chosen} could be used.

Step 132 involves outputting the corresponding chosen integer value n_{chosen}. The corresponding chosen integer value n_{chosen} may be written into the memory of the image signal processor and used many epochs after the conclusion of the training stage of the image signal processor. The chosen integer value n_{chosen} may be alternatively be called the chosen number of applications (of the predetermined filter).

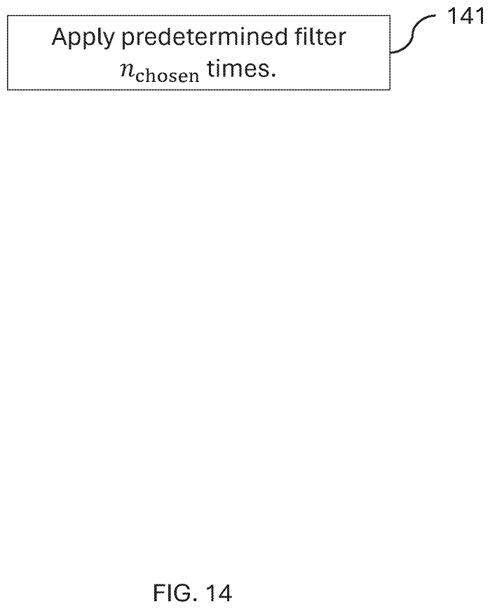

FIG. 14 describes a method that takes place when the image signal processor 302 is used for inference. The image signal processor 302 may be in use in any circumstance where filtering of image data takes place. In step 141, the predetermined filter is applied to input data n_{chosen} times. The predetermined filter of the first embodiment may be applied by a processor that comprises a multiply-accumulate unit. Accordingly, the filter can be applied to input data efficiently. The ISP 302 may multiply input data by bit-shifting the input data to apply the filter. For example, a kernel that applies a filter that sums four adjacent pixel values and then divides the summed value by four to obtain an average of the four adjacent pixel values could perform the division by bit-shifting the summed value twice.

After the image data has been processed to apply the filter, the processed image data can further be sent to the neural network processing apparatus 318 as described in connection with the first embodiment.

The above embodiments are to be understood as illustrative examples of the invention. Further embodiments of the invention are envisaged. For example, the ISP 302 described above could be implemented in hardware by providing dedicated circuitry. Alternatively, the functionality can be implemented in a software model.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method performed by an information processing apparatus, the method comprising:
obtaining input data;
parameterising a kernel that corresponds to a number of applications of a predetermined filter by a continuous variable associated with the number of applications of the predetermined filter;
determining a derivative of a coefficient of the kernel applied to the input data with respect to the continuous variable; and
outputting the derivative.

2. The method of claim 1, further comprising:
receiving a rate of change of loss with respect to the coefficient of the kernel from a neural network;
multiplying the received rate of change of loss by the derivative to determine a rate of change of loss with respect to the continuous variable; and
adjusting a number of applications of the predetermined filter based on the determined rate of change of loss with respect to the continuous variable.

3. The method of claim 2, further comprising:
using the derivative to obtain a chosen number of applications of the predetermined filter that causes a loss function to meet an exit criteria; and
storing the chosen number of applications.

4. The method of claim 2, wherein adjusting the number of applications of the predetermined filter comprises:
using the rate of change of loss with respect to the continuous variable with a gradient descent algorithm to determine the value of the chosen number of applications of the predetermined filter; and
mapping the value of the chosen number of applications of the predetermined filter to determine an integer chosen number of applications of the predetermined filter.

5. The method of claim 4, further comprising, in an inference phase, deploying the integer chosen number of times to apply the predetermined filter in an image signal processor, the image signal processor applying the predetermined filter the integer chosen number of times to second input data that is input during the inference phase to generate processed second input data.

6. The method of claim 1, wherein the input data comprises pixel values, and applying the predetermined filter to the input data comprises determining a weighted sum of adjacent pixel values of the input data.

7. The method of claim 6, wherein applying the predetermined filter to the input data further comprises bit shifting the summed input data.

8. The method of claim 6, wherein the kernel comprises a plurality of coefficients, the method further comprising modelling the plurality of coefficients of the kernel as a Gaussian distribution determined by the number of applications of the predetermined filter.

9. The method of claim 8, wherein determining a derivative of the kernel with respect to the continuous variable comprises analytically calculating a derivative of the Gaussian distribution with respect to the continuous variable.

10. The method of claim 8, wherein the derivative of the Gaussian distribution with respect to the number of applications of the predetermined filter is normalised with respect to a reference value.

11. The method of claim 1, further comprising:
determining a first kernel, wherein the first kernel corresponds to applying the predetermined filter to the input data a first number of times;
determining a second kernel, wherein the second kernel corresponds to applying the predetermined filter to the input data a second number of times; and
interpolating between entries in the first kernel and entries in the second kernel to obtain a rate of change of the kernel with respect to the continuous variable.

12. The method of claim 11, wherein interpolating between the first kernel and the second kernel comprises linearly interpolating between entries in the first kernel and corresponding entries in the second kernel.

13. The method of claim 11, wherein interpolating between the first kernel and the second kernel comprises non-linearly interpolating between entries in the first kernel and corresponding entries in the second kernel.

14. The method of claim 1, wherein the input data comprises data from an image, and the loss function is calculated by comparing a predicted characteristic of the image to labelled input data in a training set.

15. The method of claim 1, wherein the predetermined filter corresponds to a two-dimensional equivalent of a one-dimensional filter (1, 2, 1).

16. The method of claim 1, wherein the predetermined filter is a filter for controlling at least one of image sharpness, image blurring, a demosaicing parameter, a denoising parameter, and a white balance parameter.

17. The method of claim 16, wherein the outputted derivative is used to adjust the number of times that the filter is applied for use in at least one of computer vision, image recognition, and object identification.

18. An information processing apparatus comprising:
a storage; and
a processor configured to perform the method of claim 1.

19. A method performed by a system comprising an image signal processor, the method comprising:
receiving, by the image signal processor, from an information processing apparatus that performs the method of claim 5, the integer chosen number of times to apply the predetermined filter; and
applying the predetermined filter the integer chosen number of times to second input data that is input during the inference phase to generate processed second input data.

20. The method of claim 19, performed by the system comprising an image signal processor and a neural network processor, the method further comprising:
receiving, by the neural network processor, the processed second input data; and
performing inference on the processed second input data using a neural network.
